(19) United States
(12) Patent Application Publication
(10) Pub. No.: US 2021/0186073 A1
(43) Pub. Date: Jun. 24, 2021

(54) FLAVOR DELIVERY SYSTEM

(71) Applicant: GIVAUDAN SA, Vernier (CH)

(72) Inventors: Michael CHANEY, Ludlow, KY (US); Ioana Maria UNGUREANU, Cincinnati, OH (US)

(21) Appl. No.: 16/077,805

(22) PCT Filed: Mar. 13, 2017
(86) PCT No.: PCT/EP2017/055782

§ 371 Date: Aug. 14, 2018

Related U.S. Application Data
(60) Provisional application No. 62/308,108, filed on Mar. 14, 2016.

(51) Int. Cl. A23L 27/00; A23L 7/196; A23L 25/00; A23L 7/126

(52) U.S. Cl. CPC A23L 27/72; A23L 7/196; A23V 2002/00; A23L 7/126; A23L 25/20

(57) ABSTRACT

A delivery system is provided. The flavor delivery systems includes from about 1% to about 15% by weight of the system of at least one non-aqueous flavorant; and an encapsulant selected from one or more seeds in which the at least one non-aqueous flavorant is disposed. The flavor delivery system exhibits a T50 at 30° C. of greater than about 30 minutes.

### FIELD OF THE INVENTION

The present disclosure relates to delivery systems. More particularly, the present disclosure relates to the use of seeds as sustained release delivery systems for delivering non-aqueous flavorants to consumers in various food and beverage products.

### BACKGROUND OF THE INVENTION

Flavorants can be important in any food formula and can influence the finished product quality and cost. It is important to harness flavorants and aromas to make products appealing to consumers for as long as possible after the product is initially produced. However, the complex systems associated with flavorants are often difficult and expensive to control. For example, many flavorants contain top notes, such as dimethyl sulfide and acetaldehyde, which are quite volatile, vaporizing at or below room temperature. These top notes are often what give foods their fresh flavors. Because aroma and flavorings are usually delicate and volatile, their retention, particularly in high moisture and elevated temperature applications, is a concern for food manufacturers. Manufacturing and storage processes, packaging materials and ingredients in foods often cause modifications in overall flavor by reducing aroma compound intensity or producing off-flavor components. In addition, once a product is on the store shelf, oxidation, hydrolysis, staling, and other processes may also cause it to lose its desired attributes and develop off-flavors.

To limit aroma degradation during processing and storage and retain aroma and flavor in a food product, it is beneficial to encapsulate the volatile flavorants prior to use in foods or beverages. Encapsulation systems represent an important field of interest for the flavour industry. Encapsulated systems are designed to achieve two kinds of objectives.

The first objective relates to the function of protecting the ingredients entrapped in such systems. In fact, these systems must be capable of protecting an active material encapsulated therein from different kinds of retrogradation and at the same time of preventing the escape of the active material, especially of volatile flavouring component(s). Oxidation of flavours, such as essential oils, resulting in off-notes, poses serious problems for the food industry. Carbohydrates as a class offer a food-acceptable substrate in which volatiles and aromatics have been encapsulated with a certain degree of success. However most water-soluble carbohydrates are hygroscopic and will not reliably hold the encapsulate for long periods. The stabilization of encapsulation systems therefore remains a critical issue in the field.

Another objective, that is always a target for an encapsulated system, is to control (depending on the final application) the release rate and time of release of the active ingredient. In particular, if the active is volatile, it is generally of much importance to effectively prevent its release during storage, but at the same time to ensure that the encapsulation system will release the volatile active ingredient during use, triggered by conditions that are typical of such use.

In recent years, there has been a trend towards clean label formulations and labels. Some consumers desire products free of preservatives and artificial ingredients and prefer to consume products developed with natural ingredients. The ability to infuse or load flavorants into seeds provides a delivery system that provides “clean label” foods and beverages.

Accordingly, there remains a need for a delivery system utilizing more natural compounds for encapsulating flavorants to reduce artificial or modified ingredients. Moreover, there remains a need to provide non-aqueous flavorants in a stable form for use in aqueous systems such as food and beverage products, so that the flavorant is stable to oxidation and hydrolysis during the shelf life of the food or beverage product. There also remains a need for a delivery system that provides for the retention of costly flavorants without masking or dampening of flavor, while providing high flavor loading.

### SUMMARY OF THE INVENTION

In one embodiment, a delivery system includes from about 5% to about 10% by weight of the system of at least one non-aqueous flavorant having an octanol/water partitioning coefficient log P of less than 3; and an encapsulant selected from one or more seeds in which the at least one non-aqueous flavorant is disposed. The delivery system exhibits a T50 of greater than about 30 minutes.

In another embodiment, a delivery system includes from about 1% to about 15% by weight of the system of at least one non-aqueous flavorant having an octanol/water partitioning coefficient log P of less than 3; and an encapsulant selected from seeds and grains in which the at least one non-aqueous flavorant is disposed. The delivery system exhibits an induction point of greater than about 50 hours.

These and other features, aspects and advantages of specific embodiments will become evident to those skilled in the art from a reading of the present disclosure.

### BRIEF DESCRIPTION OF THE DRAWINGS

While the specification concludes with claims which particularly point out and distinctly claim the present invention, it is believed that the present invention will be better understood from the following description of preferred embodiments, taken in conjunction with the accompanying drawings, in which like reference numerals identify identical elements and wherein:

FIG. 1 is a graphical representation of the dissolution profiles for delivery systems according to one or more embodiments illustrated and described herein.

### DETAILED DESCRIPTION OF THE INVENTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

The present disclosure relates to sustained release seed delivery systems for delivering non-aqueous flavorants to consumers in various food and beverage products. The delivery systems according to the present disclosure include an encapsulant selected from one or more seeds and at least one non-aqueous flavorant disposed therein providing protection against moisture and oxidation and allowing release of the flavorant in a controllable manner under specific conditions, for example, under the influence of shear forces, heat or moisture, for instance, during chewing.

“Sustained release” refers to non-aqueous flavorants that may be released from an encapsulant, for example, a seed, at a controlled rate such that consumer preferred levels of a flavorant are maintained over an extended period of time.

A. Delivery System

One of the most important criterion for consumer acceptance of foods is flavor. In response, Applicants have developed a delivery system that makes it possible to deliver non-aqueous flavorants to consumers in various food and beverage products such that consumer preferred levels of a flavorant are maintained over an extended period of time.

According to the present disclosure, delivery systems may include, at least one non-aqueous flavorant; and an encapsulant selected from one or more seeds in which the at least one non-aqueous flavorant is disposed. The delivery systems may also include other optional ingredients for particular applications.

Dissolution profile as used herein, means a plot of the cumulative amount of flavorant released as a function of time. For example, the T50 of a delivery system is the time for the system to release 50% of the flavorant, measured as the halfway point between the time axis and the extent of release. Similarly, the T90 of a delivery system is the time for the system to release 90% of the flavorant. In one embodiment, the flavor delivery system exhibits a T50 of greater than about 30 minutes as measured according to a USP Type 2 Dissolution Test (30° C. & 150 rpm). In another embodiment, the flavor delivery system exhibits a T50 of greater than about 50 minutes; in yet another embodiment the flavor delivery system exhibits a T50 of greater than about 100 minutes; and in yet another embodiment the flavor delivery system exhibits a T50 of greater than about 200 minutes.

In another embodiment, the flavor delivery system exhibits a T0 of greater than about 150 minutes as measured according to a USP Type 2 Dissolution Test (30° C. & 150 rpm). In another embodiment, the flavor delivery system exhibits a T0 of greater than about 250 minutes; and in yet another embodiment the flavor delivery system exhibits a T90 of greater than about 600 minutes.

It is also important for delivery systems according to the present disclosure to have good oxidative stability, i.e. a system that is less susceptible to oxidative degradation. Oxidative stable flavors are important in order to prevent rancidity. Rancidity is associated with degradation by oxygen in the air via a free radical process. The double bonds of an unsaturated fatty acid can undergo cleavage, releasing volatile aldehydes and ketones which result in off-flavors. Rancidity may also be a result of the cleavage of double bonds in terpenes and other unsaturated hydrocarbons, resulting in chemical compounds of differing tastant character, strength and impact than the original flavor chemical. A flavorant which is not readily stable against oxidation may be classified as easily rancidified or oxidatively unstable.

A number of methods are well known to those skilled in the art for determining oxidative stability. In the present embodiment, the OXITEST Oxidation test reactor provided by Velp Scientifica, Italy was used to measure oxidative stability. The end point, or induction point, is determined according to ASTM D942, IP method. The longer the induction point (measured in hours), the more stable the delivery system. In one embodiment, the induction point for a delivery system according to the present disclosure is greater than 50 hours; in another embodiment the induction point is greater than 100 hours; and in another embodiment, the induction point is greater than 200 hours.

The delivery systems according to the present disclosure, effectively entrap the flavorants and/or prevent degradation thereof during storage and processing, for example when incorporated in a food or beverage, and will release the flavorant with a controllable delay under specific conditions.

The delivery system of the present disclosure may be used in a wide variety of consumables or applications and is not restricted to any particular physical mode or product form. According to the present disclosure, the term “consumable” refers to products for consumption by a subject, typically via the oral cavity (although consumption may occur via non-oral means such as inhalation), for at least one of the purposes of enjoyment, nourishment, or health and wellness benefits. Consumables may be present in any form including, but not limited to, liquids, solids, semi-solids, tablets, capsules, lozenges, strips, powders, gels, gums, pastes, slurries, syrups, aerosols and sprays. The term also refers to, for example, dietary and nutritional supplements. Consumables include compositions that are placed within the oral cavity for a period of time before being discarded but not swallowed. It may be placed in the mouth before being consumed, or it may be held in the mouth for a period of time before being discarded.

Broadly, consumables include, but are not limited to, foodstuffs of all kinds, confectionery products, baked products, sweet products, savoury products, fermented products, dairy products, beverages, oral care products, nutraceuticals and pharmaceuticals.

Exemplary foodstuffs include, but are not limited to, chilled snacks, sweet and savoury snacks, fruit snacks, chips/crisps, extruded snacks, tortilla/corn chips, popcorn, pretzels, nuts, other sweet and savoury snacks, cereal bars (for example, snack bars, granola bars, muesli bars, breakfast bars, energy bars, fruit bars, nutrition bars and meal replacement bars), slimming products, meal replacement products, convalescence drinks, ready meals, canned ready meals, frozen ready meals, dried ready meals, chilled ready meals, dinner mixes, meat analogues, frozen pizza, chilled pizza, soup, canned soup, dehydrated soup, instant soup, chilled soup, UHT soup, frozen soup, pasta, canned pasta, dried pasta, chilled/fresh pasta, noodles, plain noodles, instant noodles, cups/bowl instant noodles, pouch instant noodles, chilled noodles, snack noodles, dried food, dessert mixes, sauces, dressings and condiments, herbs and spices, spreads, jams and preserves, honey, chocolate spreads, nut-based spreads, and yeast-based spreads.

Exemplary confectionery products include, but are not limited to, chewing gum (which includes sugarized gum, sugar-free gum, functional gum and bubble gum), centerfill confections, chocolate and other chocolate confectionery, medicated confectionery, lozenges, tablets, pastilles, mints, standard mints, power mints, chewy candies, hard candies, boiled candies, breath and other oral care films or strips, candy canes, lollipops, gummies, jellies, fudge, caramel, hard and soft panned goods, toffee, taffy, liquorice, gelatin candies, gum drops, jelly beans, nougats, fondants, combinations of one or more of the above, and edible flavour compositions incorporating one or more of the above.

Exemplary baked products include, but are not limited to, alfajores, bread, packaged/industrial bread, unpackaged/artisanal bread, pastries, cakes, packaged/industrial cakes, unpackaged/artisanal cakes, cookies, chocolate coated biscuits, sandwich biscuits, filled biscuits, savoury biscuits and crackers, bread substitutes.

Exemplary sweet products include, but are not limited to, breakfast cereals, ready-to-eat (“rte”) cereals, family breakfast cereals, flakes, muesli, other ready to eat cereals, children's breakfast cereals, hot cereals.

Exemplary savoury products include, but are not limited to, salty snacks (potato chips, crisps, nuts, tortilla-tostada, pretzels, cheese snacks, corn snacks, potato-snacks, ready-to-eat popcom, microwaveable popcom, pork rinds, nuts, crackers, cracker snacks, breakfast cereals, meats, aspic, cured meats (ham, bacon), luncheon/breakfast meats (hotdogs, cold cuts, sausage), tomato products, margarine, peanut butter, soup (clear, canned, cream, instant, ultrahigh temperature “UHT”), canned vegetables, pasta sauces.

Exemplary dairy products include, but are not limited to, cheese, cheese sauces, cheese-based products, ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yoghurt, artisanal ice cream, dairy products, milk, fresh/pasteurized milk, full fat fresh/pasteurized milk, semi skimmed fresh/pasteurized milk, long-life/uht milk, full fat long life/uht milk, semi skimmed long life/uht milk, fat-free long life/uht milk, goat milk, condensed/evaporated milk, plain condensed/evaporated milk, flavoured, functional and other condensed milk, flavoured milk drinks, dairy only flavoured milk drinks, flavoured milk drinks with fruit juice, soy milk, sour milk drinks, fermented dairy drinks, coffee whiteners, powder milk, flavoured powder milk drinks, cream, yoghurt, plain/natural yoghurt, flavoured yoghurt, fruited yoghurt, probiotic yoghurt, drinking yoghurt, regular drinking yoghurt, probiotic drinking yoghurt, chilled and shelf-stable desserts, dairy-based desserts, soy-based desserts.

Exemplary beverages include, but are not limited to, flavoured water, soft drinks, fruit drinks, coffee-based drinks, tea-based drinks, juice-based drinks (includes fruit and vegetable), milk-based drinks, gel drinks, carbonated or non-carbonated drinks, powdered drinks, alcoholic or non-alcoholic drinks, and ready to drink liquid formulations of these beverages. This includes coffee and tea beverage filtration packaging such as tea bags, hard pods, soft pods, coffee pouches and systems in which a container incorporates the paper with the tea or coffee. The beverage package may be a “one-cup” style bag containing sufficient material, for a single serving or may be a “multi-brew” style bag containing sufficient material for more than one serving.

Exemplary fermented foods include, but are not limited to, cheese and cheese products, meat and meat products, soy and soy products, fish and fish products, grain and grain products, fruit and fruit products.

In one embodiment, consumables may be pasteurized. The pasteurization process may include, for example, ultra-high temperature (UHT) treatment and/or high temperature-short time (HTST) treatment. The UHT treatment includes subjecting the consumable to high temperatures, such as by direct steam injection or steam infusion, or by indirect heating in a heat exchanger. Generally, after the product is pasteurized, the product can be cooled as required by the particular product composition/configuration and/or the package filling application. For example, in one embodiment, the consumable is subjected to heating to about 185° F. (85° C.) to about 250° F. (121° C.) for a short period of time, for example, about 1 to 60 seconds, then cooled quickly to about 36° F. (2.2° C.)+/10° F. (5° C.) for refrigerated products, to ambient temperature for shelf stable or refrigerated products, and to about 185° F. (85° C.)+/−10° F. (5° C.) for hot-fill applications for shelf-stable products. The pasteurization process is typically conducted in a closed system, so as not to expose the consumable to atmosphere or other possible sources of contamination. Other pasteurization or sterilization techniques may also be useful, such as, for example, aseptic or retort processing. In addition, multiple pasteurization processes may be carried out in series or parallel, as necessitated by the consumable or ingredients.

Consumables may, in addition, be post processed. Post processing is typically carried out following addition of the seed delivery system. Post processing can include, for example, cooling the product solution and filling it into container for packaging and shipping. Post processing may also include deaeration of the consumable to <4.0 ppm oxygen, in another embodiment <2.0 ppm and in yet another embodiment <1.0 ppm oxygen. Deaeration, however, and other post processing tasks may be carried out prior to processing, prior to pasteurization, prior to mixing with the seed delivery system and/or at the same time as adding the seed delivery system. In addition, an inert gas (e.g., nitrogen or argon) headspace may be maintained during the intermediary processing of the product and final packaging. Additionally/alternatively, an oxygen or UV radiation barriers and/or oxygen scavengers could be used in the final packaging.

1. Non-Aqueous Flavorants

In one embodiment, a delivery system in accordance with the present disclosure may comprise at least one non-aqueous flavorant. By “flavorant” it is meant a composition created by a flavorist using methods known to the skilled person that is a mixture of tastants, aroma compounds and sensates. In one embodiment, non-aqueous flavorants may include any one or more food-grade flavorants that do not substantially dissolve in water. The flavorant may be a liquid, gel, colloid, or particulate solid, for example, an oil, an extract, an oleoresin, or the like.

The logarithm of the octanol/water partition coefficient (log P) is used extensively to describe the lipophilic or hydrophobic properties of an active element, for example, a flavorant. The log P property value is taken from the ratio of the respective concentrations of an active element in the n-octanol and water partitions of a two phase system at equilibrium. The non-aqueous flavorants may be characterized by log P values. In one embodiment, suitable non-aqueous flavorants may have a log P of less than 3. In another embodiment, suitable non-aqueous flavorants may have a log P in the range of from about 0.5 to about 3.0, or any individual number within the range. In another embodiment, the log P may be from about 1 to about 2.5.

Examples of suitable flavorants include natural flavors, artificial flavors, spices, seasonings, and the like. Exemplary flavorants include synthetic flavor oils and flavoring aromatics and/or oils, oleoresins, essences, and distillates, and a combination comprising at least one of the foregoing.

Flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents include artificial, natural and synthetic fruit flavors such as vanilla, and citrus oils including lemon, orange, lime, grapefruit, yuzu, sudachi, and fruit essences including apple, pear, peach, grape, raspberry, blackberry, gooseberry, blueberry, strawberry, cherry, plum, prune, raisin, cola, guarana, neroli, pineapple, apricot, banana, melon, apricot, cherry, tropical fruit, mango, mangosteen, pomegranate, papaya, and so forth.

Additional exemplary flavors imparted by a flavorant include a milk flavor, a butter flavor, a cheese flavor, a cream flavor, and a yogurt flavor, a vanilla flavor, tea or coffee flavors, such as a green tea flavor, an oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; a nut flavor such as an almond flavor, a hazelnut flavor, a macadamia nut flavor, a peanut flavor, a pecan flavor, a pistachio flavor, and a walnut flavor; floral flavors; and vegetable flavors, such as an onion flavor, a garlic flavor, a cabbage flavor, a carrot flavor, a celery flavor, mushroom flavor, and a tomato flavor.

According to some embodiments, flavorants may also include aldehydes and esters such as cinnamyl acetate, cinnamaldehyde, citral diethylacetal, dihydrocarvyl acetate, eugenyl 49 formate, p-methylamisol, and so forth can be used. Further examples of aldehyde flavourings include acetaldehyde (apple), benzaldehyde (cherry, almond), anisic aldehyde (licorice, anise), cinnamic aldehyde (cinnamon), citral, i.e., alpha-citral (lemon, lime), neral. i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavours), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), and the like.

Generally any flavorant or food additive such as those described in “Chemicals Used in Food Processing”, Publication No 1274, pages 63-258, by the National Academy of Sciences, can be used. This publication is incorporated herein by reference.

In certain exemplary embodiments, a desired amount of non-aqueous flavorant in the form of the above-described delivery system is included in a consumable. The amount of non-aqueous flavorant included in a consumable may vary depending on the application and desired taste characteristics of the consumable. The delivery system may be added to the consumable in any number of ways, as would be appreciated by those of ordinary skill in the art given the benefit of this disclosure. In certain exemplary embodiments, the delivery system is sufficiently mixed in the consumable to provide a substantially uniform distribution, for example a stable dispersion. Mixing should be accomplished such that the encapsulants are not destroyed. If the encapsulants are destroyed, premature release (exposure) of flavor and oxidation or hydrolysis of the non-aqueous flavorant may result. The mixer(s) can be selected for a specific application based, at least in part, on the type and amount of ingredients used, the viscosity of the ingredients used, the amount of product to be produced, the flow rate, and the sensitivity of ingredients, such as the delivery system, to shear forces.

The delivery system may include from about 1% to about 15%, in another embodiment from about 1% to about 10%, in yet another embodiment from about 1% to about 5%, or any individual number within the range, by weight of the system of at least one non-aqueous flavorant. In another embodiment, the delivery system may include from about 5% to about 10%, by weight of the system of at least one non-aqueous flavorant.

In another embodiment, active elements in addition to or in place of flavorants may be encapsulated. Examples of suitable active elements include, but are not limited to, flavor precursors, aromas, aroma precursors, taste enhancers, salts, sugars, amino-acids, polysaccharides, enzymes, peptides, proteins or carbohydrates, food supplements, food additives, hormones, bacteria, plant extracts, medicaments, drugs, nutrients, chemicals for agro-chemical or cosmetic applications, carotenoids, vitamins, nutritional supplements, antioxidants or nutraceuticals selected from the group comprising of lutein, lutein esters, β-carotene, tocopherol, tocopherol acetate, tocotrienol, lycopene, Co-Q₁₀, flax seed oil, fish oil, omega-3 oils, omega-6 oils, DHA, EPA, arachidonic-rich oils, LCPUFA oils, menthol, mint oil, lipoic acid, vitamins, polyphenols and their glycosides, ester and/or sulfate conjugates, isoflavones, flavonols, flavanones and their glycosides such as hesperidin, flavan 3-ols comprising catechin monomers and their gallate esters such as epigallocatechin gallate and their procyanidin oligomers, vitamin C, vitamin C palmitate, vitamin A, vitamin B, vitamin B₁₂, vitamin D, α- and/or γ-polyunsaturated fatty acids, phytosterols, esterified phytosterols, free, non esterified phytosterols, zeaxanthine, caffeine, and a combination thereof

2. Encapsulants

Flavoring consumables involves complicated processing. The choice of encapsulation materials depends on a number of factors including: expected product objectives and requirements; process of encapsulation; and economics.

In accordance with one embodiment, the delivery system according to the present disclosure may also include an encapsulant selected from one or more seeds in which the at least one non-aqueous flavorant is disposed. By “seeds” it is meant edible seeds that are directly foodstuffs, rather than yielding derived products, including, but not limited to, nuts, kernels, legumes, beans, grains and the like. Non-limiting examples include millet, chia, flaxseed, hemp, poppy, sesame, safflower, sunflower, pumpkin, melons, berries, quinoa, sorghum, teff, canola, rye, amaranth, barley, fonio, maize, oats, Palmer's grass, rice, spelt, triticale, wheat, barley Mitchell grass, wattle signal grass, woollybutt grass, kangaroo grass, bunch panic, breadnut, buckwheat, cattail, hanza, pitseed goosefoot and nuts (acom, almond, beech, Brazil, candlenut, cashew, chestnut, hazel, coconut, hickory, kola, macadamia, pistachio, pine and walnuts).

In one embodiment, the seeds are generally raw, whole, unroasted edible seeds. By whole seeds it is meant that they are not compressed, defatted or fractured and may include complete, unbroken seeds as well as partial, whole seed pieces and combinations thereof. In another embodiment, ground seed meal may be used.

The process of infusing or loading the seeds with flavorant and/or active elements involves increasing the porosity of the seeds by gently heating the seeds to a temperature of about 30° C. to about 40° C. while mixing. This causes the seeds coating to expand and make the coating more permeable. After loading, the seeds are cooled, essentially locking the flavorant in the seeds.

3. Optional Ingredients

The delivery system and consumables may, optionally, include additional ingredients which include, but are not limited to, colorings, thickeners, water-soluble flavorants, electrolytes, anti-foaming agents, stabilizers, emulsifiers, preservatives, gums, starches, dextrins, vitamins and minerals, functional ingredients, salts, sweeteners, and polyunsaturated fatty acids.

### EXAMPLES

The following examples are given solely for the purpose of illustration and are not to be construed as limitations of the present invention, as many variations of the invention are possible without departing from the spirit and scope of the present disclosure.

### Examples 1-4 and Comparative Examples A-C

These examples illustrate the preparation of delivery systems according to the present disclosure.

The encapsulants used in Examples 1-4 were as follows: Example 1 (Millet); Example 2 (Amaranth); Example 3 (Quinoa); and Example 4 (Sesame). In Comparative Example A, a commercially available spray dry delivery system (EverFresh 100 from Givaudan Flavors Corp.) loaded with 10% methyl salicylate was prepared. In Comparative Example B, a commercially available coacervate delivery system (EverFresh 400 from Givaudan Flavors Corp.) loaded with 15% methyl salicylate was prepared. In Comparative Example C, a commercially available cross-linked alginate delivery system (EverFresh 800 from Givaudan Flavors Corp.) loaded with 20% methyl salicylate was prepared.

Examples 1-4 were prepared as follows: 38 grams of each type of seed were placed in separate 4 ounce bottles; 2 grams (5% by weight) of methyl salicylate was added to each bottle and heated to 40° C.; each bottle was then placed on a roller mill (SCILOGEX MX-T6-S Analog Tuber Roller) and mixed for 60 minutes. Delivery systems prepared in accordance with Examples 1-4 and Comparative Examples A-C were evaluated for dissolution. The dissolution tests were conducted in an automated USP dissolution apparatus (Paddle Type II), and the release of methyl salicylate was analyzed via UV analysis. The results listed below in Table 1.

TABLE 1
Dissolution Results

| | T50 (min) | T90 (min) |
|---|---|---|
| Examples | 30° C. & 150 rpm | 30° C. & 150 rpm |
| Ex. 1 | 50.25 | 260.25 |
| Ex. 2 | 76.00 | 182.00 |
| Ex. 3 | 82.00 | 253.00 |
| Ex. 4 | 221.25 | 695.25 |
| C. Ex. A | 0.10 | 0.87 |
| C. Ex. B | 2.97 | 11.05 |
| C. Ex. C | 24.20 | 102.10 |

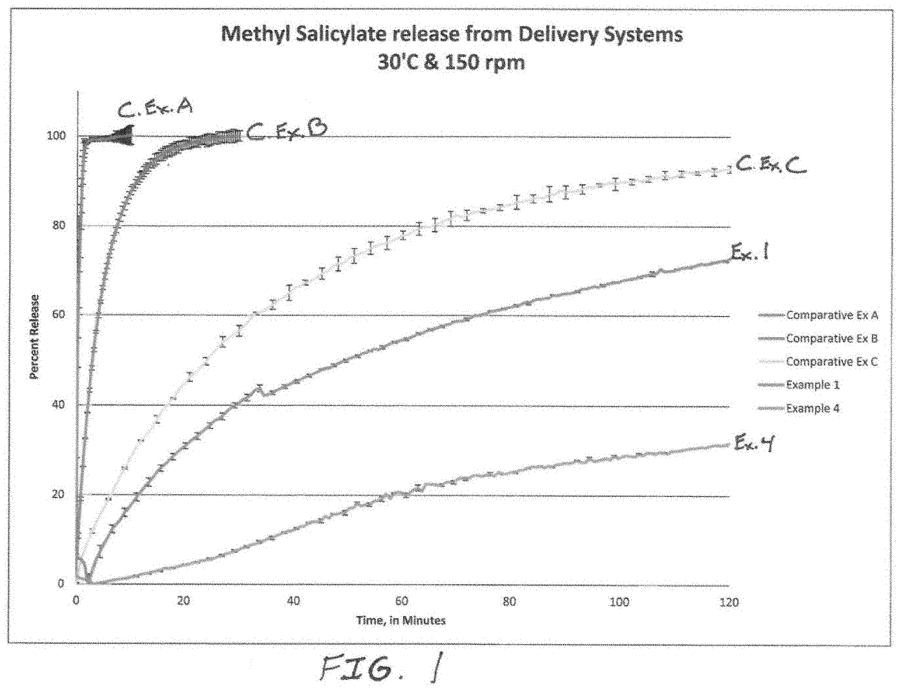

The dissolution results are also graphically depicted in FIG. 1. The dissolution results demonstrate that the delivery systems according to the present disclosure (Examples 1-4) provide a slower and sustained release of the methyl salicylate as compared to Comparative Examples A-C.

### Examples 5-7

These examples illustrate the preparation of delivery systems according to the present disclosure.

The encapsulants used in Examples 5-7 were as follows: Example 5 (Sesame); Example 6 (Quinoa); and Example 7 (Millet).

Examples 5-7 were prepared as follows: 34 grams of each type of seed were placed in separate 4 ounce bottles; 2 grams of deionized water and 4 grams (10% by weight) of strawberry flavor (available from Givaudan Flavors Corp.) was added to each bottle and heated to 40° C.; each bottle was then placed on a roller mill (SCILOGEX MX-T6-S Analog Tuber Roller) and mixed for 60 minutes. Delivery systems prepared in accordance with Examples 5-7 were evaluated for dissolution. The dissolution tests were conducted in an automated USP dissolution apparatus (Paddle Type II), and the release of strawberry flavor was analyzed via UV analysis. The results listed below in Table 2.

TABLE 2
Dissolution Results

| | T50 (min) | T90 (min) |
|---|---|---|
| Examples | 30° C. & 150 rpm | 30° C. & 150 rpm |
| Ex. 5 | 217 | 694 |
| Ex. 6 | 39 | 296 |
| Ex. 7 | 52 | 346 |

### Example 8

Chicken nuggets were prepared according to the present disclosure and tasted by a sensory panel. The chicken nuggets were prepared as follows: sesame seeds were loaded with 10% by weight ginger flavorant in the same manner as Example 4. Next, chicken breasts were cut into equal size pieces and separated into four groups (8A, 8B, 8C and 8D) each weighing approximately 100 grams. Three groups of chicken pieces were then breaded with Japanese Panko Breadcrumbs (available from Newly Weds Foods Australia) according to the following seed/breading ratios and fried.

TABLE 3

| Examples | % Sesame Seeds | % Breading |
|---|---|---|
| 8A | 18.75% | 81.25% |
| 8B | 25% | 75% |
| 8C | 31.25% | 68.75% |
| 8D | 0.0% | 100% |

The ginger chicken nuggets prepared according to Table 3 were taste tested by a sensory panel comprising six testers. According to the sensory panel, the flavorant survived the frying process and was noticeably present in the finished food application for Examples 8A, 8B and 8C. According to the panelists, Examples 8A, 8B and 8C showed an intensity and sustained profile of flavor through the chewing and consumption process. Without the protection of the enscapulant according to the present disclosure, one skilled in the art would expect an unprotected flavor oil used in such application to demonstrate a major loss of flavor, impact and profile as a result of the processing and preparation.

### Example 9

Granola bars were prepared according to the present disclosure and tasted by a sensory panel. The granola bars were prepared as follows: sesame seeds were loaded with 10% by weight brown sugar flavorant in the same manner as Example 4; a binder (mixture of corn syrup, high fructose corn syrup, glycerine, sorbitol, sucrose sugar, CRISCO shortening and dextrose) was placed in a mixing bowl and softened in a microwave oven; sesame seeds were added to the binder and mixed; next, maltodextrin and salt were added and mixed; dry ingredients (mixture of rolled oats, crisp rice, whole grain flakes cereal) were mixed and then added to the mixing bowl and all components in mixing bowl were stirred; 50 grams of material was poured into a mold and pressed firm with a spatula; this step was repeated until no more material was left; the molds were left to cool for 30 minutes or more until the bars were set; bars were removed from the molds. Four groups of bars were prepared according to the above procedure according to the following seed use levels:

TABLE 4

| | % Sesame Seed | % Cereal Bar | |
|---|---|---|---|
| Examples | Use Level | Base | Taste Results |
| 9A | 1.00 | 99.00 | Light impact |
| 9B | 2.00 | 98.00 | Strong but |
| | | | pleasant |
| 9C | 3.00 | 97.00 | Too high |
| 9D | 4.00 | 96.00 | Dusty, bitter, |
| | | | earthy, dirty, |
| | | | molasses, heavy |
| | | | sulfury |

The brown sugar granola bars prepared according to Table 4 were taste tested by a sensory panel comprising five testers. According to the panelists, the Examples showed an intensity and sustained profile of flavor through the chewing and consumption process. Without the protection of the enscapulant according to the present disclosure, one skilled in the art would expect an unprotected flavor oil used in such application to demonstrate an initial strong impact, but fade quickly with chewing.

### Examples 10-12 and Comparative Examples

These examples illustrate the oxidative stability of delivery systems according to the present disclosure as compared to non-encapsulated flavorants.

The encapsulants used in Examples 10, 11 and 12 were as follows: Example 10 (Quinoa), Example 11 (Sesame) and Example 12 (Millet). Example 10 was loaded with 5% lemon flavorant, Example 11 was loaded with 2.5% limonene and Example 12 was loaded with 2% limonene. Comparative Example 10A was an equivalent weight of lemon flavorant, Comparative Example 1A was an equivalent weight of limonene flavorant, and Comparative Example 12A was an equivalent weight of limonene flavorant. These Examples were evaluated for oxidative stability by the OXITEST (55° C. and 6 bar). The induction points for these Examples are provided below in Table 5.

TABLE 5
OXITEST Results

| | Induction Point for | Induction Point for |
|---|---|---|
| | delivery system | flavorant |
| Examples | (hours) | (hours) |
| 10 | 159:56 | |
| 10A | | 4:31 |
| 11 | 222:59 | |
| 11A | | 15:54 |
| 12 | 68:06 | |
| 12A | | 10:10 |

The induction point results demonstrate that the delivery systems according to the present disclosure (Examples 10, 11 and 12) provide a more oxidative stable delivery system as compared to Comparative Examples 10A, 11A and 12A. In fact, the results in Table 5 demonstrate an at least 600% improvement in the oxidative stability of delivery systems according to the present disclosure as compared to non-encapsulated flavorants.

### Test Methods

The test method and apparatus described below may be useful in testing embodiments of the present disclosure:

### USP Type 2 Dissolution Testing

### Equipment

Distek OPT-DISS multi-channel fiber optic UV spectrophotometer;
900 mL dissolution vessels and paddle stirrers
Analytical Balance: Mettler Toledo AG245 with weighting range (max 210 g/0.1 mg)
   All dissolution testing was performed in accordance with USP Type 2 (Paddle Apparatus). The dissolution medium was deionized water at 30° C. The volume of the dissolution medium was 900 mL and the rotation speed of the paddle was 150 rpm. Samples were withdrawn at suitable time intervals for content of the flavorant by means of UV spectrometry at an analytical wavelength of 284 nanometers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A delivery system comprising:
from about 1% to about 15% by weight of the system of at least one non-aqueous flavorant having an octanol/water partitioning coefficient log P of less than 3; and
an encapsulant selected from seeds and grains in which the at least one non-aqueous flavorant is disposed;
wherein the delivery system exhibits a T50 at 30° C. of greater than about 30 minutes.

2. The delivery system according to claim 1, wherein the system includes from about 1% to about 10% by weight of the system of at least one non-aqueous flavorant having an octanol/water partitioning coefficient log P of less than 3.

3. The delivery system according to claim 1, wherein the encapsulant is selected from the group consisting of sesame seeds, quinoa and millet.

4. The delivery system according to claim 1, wherein the system exhibits a T50 at 30° C. of greater than about 50 minutes.

5. A consumable comprising the delivery system according to claim 1.

6. The delivery system according to claim 1, further comprising an active element.

7. The delivery system according to claim 1, further comprising at least one member selected from the group consisting of colorings, thickeners, water-soluble flavorants, electrolytes, anti-foaming agents, stabilizers, emulsifiers, preservatives, gums, starches, dextrins, vitamins and minerals, functional ingredients, salts, sweeteners, and polyunsaturated fatty acids.

8. The delivery system according to claim 1, wherein the delivery system exhibits an induction point of greater than about 50 hours.

9. A delivery system comprising:
from about 1% to about 15% by weight of the system of at least one non-aqueous flavorant having an octanol/water partitioning coefficient log P of less than 3; and
an encapsulant selected from seeds and grains in which the at least one non-aqueous flavorant is disposed;
wherein the delivery system exhibits an induction point of greater than about 50 hours.

10. The delivery system according to claim 9, wherein the system includes from about 1% to about 10% by weight of the system of at least one non-aqueous flavorant having an octanol/water partitioning coefficient log P of less than 3.

11. The delivery system according to claim 9, wherein the encapsulant is selected from the group consisting of sesame seeds, quinoa and millet.

12. The delivery system according to claim 9, wherein the system exhibits an induction point of greater than about 100 hours.

13. A consumable comprising the delivery system according to claim 9.

14. The delivery system according to claim 9, further comprising an active element.

15. The delivery system according to claim 9, further comprising at least one member selected from the group consisting of colorings, thickeners, water-soluble flavorants, electrolytes, anti-foaming agents, stabilizers, emulsifiers, preservatives, gums, starches, dextrins, vitamins and minerals, functional ingredients, salts, sweeteners, and polyunsaturated fatty acids.

16. The delivery system according to claim 9, wherein the delivery system exhibits an induction point of greater than about 200 hours.

17. A cereal bar comprising:
dry ingredients;
a binder; and
a deliver system, wherein the delivery system includes from about 1% to about 15% by weight of the system of at least one non-aqueous flavorant; and an encapsulant selected from seeds and grains in which the at least one non-aqueous flavorant is disposed; and wherein the delivery system exhibits a T50 at 30° C. of greater than about 30 minutes.

18. The cereal bar according to claim 17, wherein the encapsulant is sesame seeds.

19. The cereal bar according to claim 17, wherein the delivery system exhibits an induction point of greater than about 50 hours.
